(19) United States
(12) Patent Application Publication
(10) Pub. No.: US 2016/0140638 A1
(43) Pub. Date: May 19, 2016

(54) ONE-CLICK REFUNDS FOR ONLINE CONTENT PURCHASES

(71) Applicants: Robert Jonathan Ennals, Palo Alto, CA (US); Udi Manber, Los Altos Hills, CA (US); James Home, San Francisco, CA (US)

(72) Inventors: Robert Jonathan Ennals, Palo Alto, CA (US); Udi Manber, Los Altos Hills, CA (US); James Home, San Francisco, CA (US)

(73) Assignee: GOOGLE Inc., Mountain View, CA (US)

(21) Appl. No.: 13/463,755

(22) Filed: May 3, 2012

(51) Int. Cl. G06Q 30/06

(52) U.S. Cl. CPC G06Q 30/0623

(57) ABSTRACT

The present invention provides a computer-implemented method to provide an option to a purchaser to refund a purchase. A content distributor system (“CDS”) receives content from a content provider. The CDS presents an option to purchase online content to a user operating a user network device. The CDS presents a refund option to the user before the user makes the purchase and while evaluating the content. The CDS receives an indication that the user initiated a purchase of the product and provides the content to the user. The CDS determines a length of time for which the refund option is valid before the refund option is terminated. If the user requests a refund, the CDS refunds the user purchase and the CDS transmits instructions to render the content unusable. If the time expires and the refund option has not been initiated, the CDS conducts the transaction.

### TECHNICAL FIELD

The present disclosure relates generally to online content marketing, and more particularly to providing a user with a one-click refundable purchase option.

### BACKGROUND

Online content distributors sell news articles, videos, blogs, games, music or other content to online customers. Online purchases are risky to a customer because, unlike a product at a physical merchant, an online product can't be held or examined before purchase.

A content distributor can present a preview to entice a user to purchase online content, but the user may still be wary. Users might refuse a purchase because they do not know if the content will be worth the cost. A user may feel that purchasing the content from a content distributor is a gamble because if the content is not what the user thought it would be or if it does not meet the user's needs, the user cannot easily obtain a refund. A user may believe that, because many items of online content are low cost items, it would not be worth even a minimal amount of effort to obtain a refund.

Further, online content providers may be hesitant to develop higher quality content because the purchase rate among users remains low. The content distributors would like to obtain higher purchase rates to encourage higher quality content. That is, content providers may be motivated to improve the quality and quantity of the content if the content distributors could provide higher purchase rates.

### SUMMARY

An aspect of the present invention provides a computer-implemented method to provide an option to a purchaser to refund a purchase. A content distributor system (“CDS”) receives content from a content provider. The CDS presents an option to purchase online content to a user operating a user network device and presents a refund option to the user before the user makes the purchase. The CDS receives an indication that the user initiated a purchase of the product and provides the content to the user. The CDS determines a length of time for which the refund option is valid before the refund option is terminated. If the user requests a refund, the CDS refunds the user purchase and the CDS transmits instructions to render the content unusable on the user network device. If the time expires and the refund option has not been initiated, the CDS conducts the transaction.

Another aspect of the present invention provides a computer program product that is installed on a server located in a content distributor system to provide an option to a purchaser to refund a purchase. The computer program product includes a non-transitory computer-readable storage device having computer-readable program instructions embodied thereon. The computer-readable program instructions include computer program instructions for receiving content from a content provider; present an option to purchase online content to a user operating a user network device; present a refund option to a user; receive an indication that the user initiated a purchase of the product; provide the content to the user; determine a length of time for which the refund option is valid before the refund option is terminated; refund the purchase of the content if the refund option is initiated before the length of time is exceeded; conduct the transaction if the length of time is exceeded and the refund option has not been initiated; and transmit instructions to render the content unusable on the user network device if the refund is initiated by the user.

Another aspect of the present invention provides an option to a purchaser to refund a purchase. A content distribution system contains a content distribution system server. The server is configured to receive content from a content provider; present an option to purchase online content to a user operating a user network device; present a refund option to a user; receive an indication that the user initiated a purchase of the product; provide the content to the user; determine a length of time for which the refund option is valid before the refund option is terminated; refund the purchase of the content if the refund option is initiated before the length of time is exceeded; conduct the transaction if the length of time is exceeded and the refund option has not been initiated; and transmit instructions to render the content unusable on the user network device if the refund is initiated by the user.

### BRIEF DESCRIPTION OF THE DRAWINGS

FIG. 1 is a block diagram depicting an operating environment of a content distribution system that is configured to provide a user with a one-click refundable purchase option, in accordance with certain exemplary embodiments.

FIG. 2 is a block flow diagram depicting a method to provide a user with a one-click refundable purchase option, in accordance with certain exemplary embodiments.

### DETAILED DESCRIPTION OF THE EXEMPLARY EMBODIMENTS

### Overview

The exemplary embodiments provide a content distribution system (“CDS”) that can offer online content to potential users. The content can be news articles, entertainment articles, games, music, videos, blogs, or other content that can be purchased and displayed from a user network device. The content can be displayed on the user network device with any application or communication module such as a web browser. The content can be provided to the CDS by a content provider server. The content provider can transmit the content to the CDS via any available technologies including, but not be limited to, an Internet connection, email, text, instant messaging, or other suitable communication technologies.

The CDS may provide the content to potential customers through any online marketing or distribution channels. In an exemplary embodiment of the invention, the CDS is a website operating on a web server that can offer online content to users for a payment. The CDS may be a search engine provider, a blog or other user provided content provider, a news organization, an entertainment site, or any other content distributor. In an alternate embodiment, the CDS and the content provider may be the same entity. For example, the same website that produces content can also distribute the content.

In an exemplary embodiment, a user may request a preview of an item of content before purchasing. The request may be the result of a search engine query, a response to an online advertisement, or any other request. The CDS can provide a preview to the user to help the user determine if the content is desirable. The preview may be a portion or example of the written content, pictures, video, music, or any content.

The CDS offers the user an opportunity to purchase the content. In an exemplary embodiment, the CDS may present the user with a button on the web browser of the user network device for a simple one-click purchase. Alternatively, the CDS may present a popup window, hyperlink, or any other user interface module to offer the purchase opportunity to the user. The user may purchase the content with any financial account available to the user and accepted by the CDS. For example, the user may have a prepaid account on the CDS, a credit or debit card account associated with the user account on the CDS, a separate financial account that is accessed by the CDS when a purchase is made, or any other financial account that can be used to conduct the transaction.

In an exemplary embodiment, the purchase module offers the user a one-click refund option along with the purchase option and with the content during the refund period. The one-click refund option is displayed to provide a level of comfort to the user that if the content is not what the user expected or needed the user will be able to quickly, securely, and easily obtain a refund. The CDS would expect that the one-click refund option would encourage a user to commit to the purchase more readily and thus increase the purchases of the content. The one-click refund option is displayed to the user before the purchase is made to encourage the purchase. Additionally or alternatively, the one-click refund button is displayed during the usage and evaluation of content. To obtain a refund, the user will not be required to call customer service or return to the CDS, find the content page, and find the refund option to obtain a refund.

In an exemplary embodiment, the refund option is displayed on the same module, on the same user interface, or on a user interface displayed in conjunction with the purchase button. Throughout the specification, the refund button, refund module, refund screen, refund popup or other embodiment of the one-click refund option shall be referred to as the refund button.

The CDS provides the content to the users that purchase the content. In the exemplary embodiment, the CDS does not charge the user financial account immediately. Even if the CDS does not immediately charge the account, the CDS may check the financial account of the user to determine if the transaction is likely to be approved and to be processed. For example, the CDS can determine if a credit account associated with the user is valid, current, and not over the credit maximum or whether a user account on the CDS is funded. In certain embodiments, whether the CDS checks the financial account or not, the CDS may provide the content to the user in anticipation of a successful transaction.

In an alternate exemplary embodiment, the refund button is displayed on the same user interface on which the content is displayed. Alternatively, the refund button is displayed in conjunction with the content. The user can directly access the refund from the user interface.

The CDS establishes the length of time that the user may possess the content before the sale becomes final. The CDS communicates to the user the deadline before which the refund button must be clicked.

If the user requests a refund before the deadline by actuating the refund button, the CDS cancels the pending transaction. That is, the purchase that was initiated by the user to receive the content is terminated by the CDS before the financial account is charged. In an alternate embodiment, if the CDS charged the financial account of the user at the time of purchase, then the charge can be refunded to the user financial account or refunded to the user in another manner, such as a purchase credit, cash refund, or any other refund mechanism.

If the user requests a refund, the CDS may instruct the web browser or other communication module operating on the user device to make the content unusable. For example, the CDS or the user device may hide, scramble, blur, or delete the content from the user device or in any other suitable manner make the content unusable.

If the user has not requested a refund by the deadline, then the refund button is removed and the user can no longer obtain a refund. In an exemplary embodiment, the user device is instructed to hide the refund button. In an alternate embodiment, the refund button continues to be displayed to the user, but the CDS ignores any attempts to obtain a refund after the deadline has passed.

If the deadline has elapsed and the user has not requested a refund, the CDS processes the transaction to complete the purchase of the content.

In an exemplary embodiment of the invention, the CDS transmits a status of the content to the user network device. The user network device maintains a status list of content that has been purchased and content that has been refunded and thus is unavailable for the user to use. By maintaining the status list on the user device, the user will not be required to wait for the user device to contact the CDS to verify the purchase and refund status.

Additionally or alternatively, the status list may be maintained on the CDS. The user device can contact the CDS to verify the status of content before presenting the content to the user. In a certain embodiment, if a user has purchased the content on one user device, the CDS may allow the content to be presented to the user on a second device. In a certain embodiment, the user device can present the content to the user during the verification process to prevent the user from being required to wait for verification. If the verification process determines that the purchase has been refunded then the content can be rendered unusable to the user via any of the previously discussed methods or any other suitable method.

The inventive functionality of the invention will be explained in more detail in the following description, read in conjunction with the figures illustrating the program flow.

### System Architecture

Turning now to the drawings, in which like numerals represent like (but not necessarily identical) elements throughout the figures, exemplary embodiments of the present invention are described in detail.

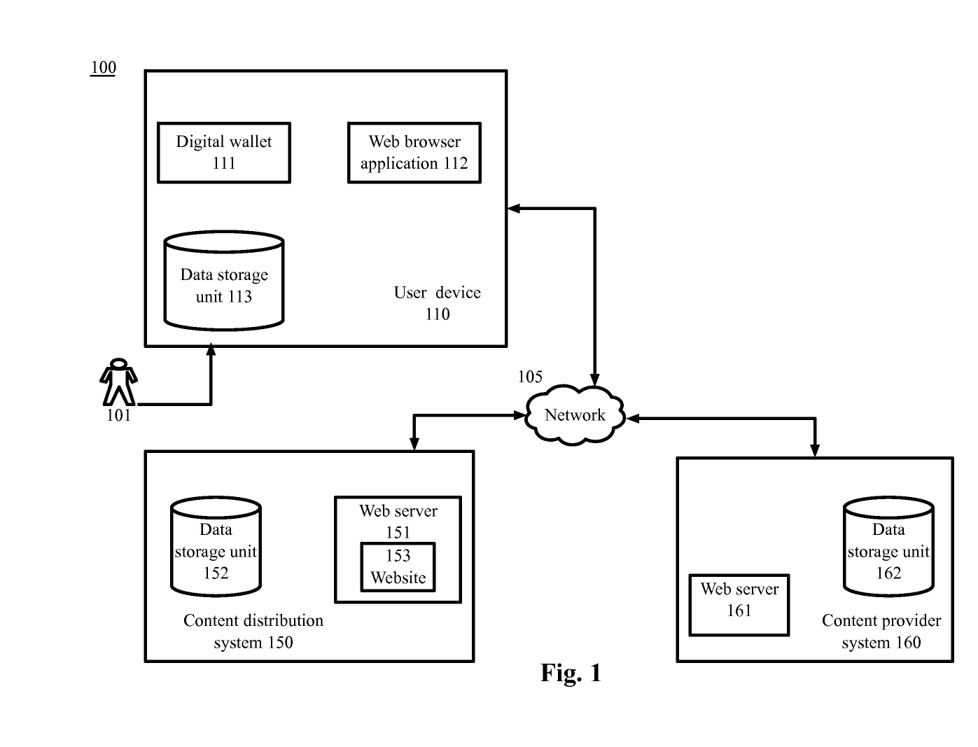

FIG. 1 is a block diagram depicting an operating environment of a content distribution system (“CDS”) that is configured to provide a user with a one-click refundable purchase option, in accordance with certain exemplary embodiments. As depicted in FIG. 1, the system 100 includes network devices 110, 150 and 160 that are configured to communicate with one another via one or more networks 105.

Each network 105 includes a wired or wireless telecommunication means by which network devices (including devices 110, 150, 160) can exchange data. For example, each network 105 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 150 and 160 includes a device having a communication module capable of transmitting and receiving data over the network 105. For example, each network device 110, 150 and 160 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 110, 150 and 160 are operated by end-users or consumers, content distributors, and content providers, respectively.

The user 101 can use the application 112, such as a web browser application or a stand-alone application, to view, download, upload, or otherwise access documents or web pages via a distributed network 105. The network 105 includes a wired or wireless telecommunication system or device by which network devices (including devices 110, 120, 150, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages. Throughout the discussion of exemplary embodiments, it should be understood that the terms “data” and “information” are used interchangeably herein to refer to text, images, audio, video, or any other form of information that can exist in a computer based environment.

The web browser application 112 can interact with web servers or other computing devices connected to the network 105, including web server 151 of the CDS 150, and the web server 161 of the content provider system 160.

The user device 110 may include a digital wallet application module 111. The digital wallet 111 may encompass any application, hardware, software, or process the user device 110 may employ to assist the device to complete a purchase transaction. The digital wallet 111 can interact with the web browser application 112 or can be embodied as a companion application of the web browser application 112. As a companion application, the digital wallet 111 executes within the web browser application 112. That is, the digital wallet 111 may be an application program embedded in the web browser application 112

The user device 110 includes a data storage unit 113 accessible by the digital wallet 111, the communication module 117, and the web browser application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The CDS 150 utilizes a CDS server 151. The CDS server 151 may represent the computer-implemented system that the CDS 150 employs to provide content to users 101, process transactions with the users 101, provide refunds, receive content, and to perform other tasks. The CDS server 151 operates a CDS website 153. The website 153 may be operable to communicate with a user 101 and a content provider system 160 and others to allow configuration of accounts, content management, or any other purpose to manage the content distribution process.

The CDS 150 can communicate with a content provider system 160 and user devices 110 via any available technologies. The technologies may include, but would not be limited to, an Internet connection via the network 105, email, text, instant messaging, or other suitable communication technologies. The CDS 150 may include a data storage unit 152 accessible by the server 151 of the CDS 150. The data storage unit 152 can include one or more tangible computer-readable storage devices.

The content provider system 160 utilizes content provider system server 161. The content provider system server 161 may represent the computer implemented system that the content provider system 160 employs to host content, transmit content to the CDS 150 and others, manage content providers, and to perform other functions. The content provider system server 161 can communicate with the CDS 150 by any available technologies. The technologies may include, but would not be limited to, an Internet connection via the network 105, email, text, instant messaging, or other suitable communication technologies. The content provider system 160 may include a data storage unit 162 accessible by the server 161 of the content provider system 160. The data storage unit 162 can include one or more tangible computer-readable storage devices.

It will be appreciated that the network connections shown are exemplary and other means of establishing a communications link between the computers and devices can be used. Moreover, those having ordinary skill in the art having the benefit of the present disclosure will appreciate that the user device 110, CDS 150, and content provider system 160 illustrated in FIG. 1 can have any of several other suitable computer system configurations. For example, a user device 110 embodied as a mobile phone or handheld computer may not include all the components described above.

### System Process

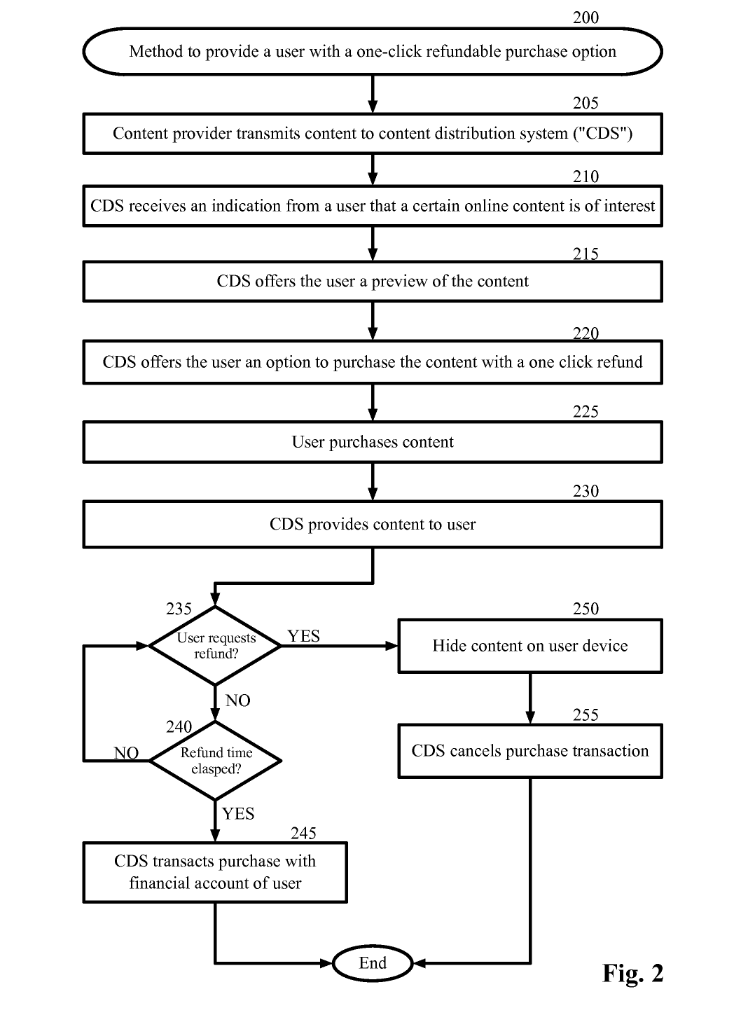

The components of the exemplary operating environment 100 are described hereinafter with reference to the exemplary methods illustrated in FIG. 2. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a flow chart depicting a method 200 to provide a user with a one-click refundable purchase option, in accordance with certain exemplary embodiments.

With reference to FIGS. 1 and 2, in block 205, a content provider 160 can provide content to a content distribution system (“CDS”) 150. The content can be news articles, entertainment articles, games, music, videos, blogs, or other content that can be purchased and displayed from a user network device 110. The content can be transmitted to the CDS 150 by a content provider server 161. The content provider system 160 can transmit the content to the CDS 150 via any available technologies including, but not be limited to, an Internet connection via the network 105, email, text, instant messaging, or other suitable communication technologies.

The CDS 150 markets the content to potential customers through any online marketing or distribution channels. In an exemplary embodiment of the invention, the CDS 150 is a website operating on a web server 151 that can offer online content to users 101 for a payment. The CDS 150 may be a search engine provider, a blog or other user generated content provider, a news organization, an entertainment site, a game provider, or any other content distributor.

In an alternate embodiment, the content provider system 160 and the CDS 150 may be the same entity. That is the CDS 150 may provide the content and distribute the content. The two functions of providing and distributing the content may be performed on the same server or multiple servers within the same system.

In block 210, the CDS 150 receives an indication that a user has expressed an interest in an item of the available content. Examples of indications that a user 101 may be interested in the item may include a search entry by the user 101, a click on a banner ad or popup ad by the user 101, a search of the buying history of the user 101 by the CDS 150, viewing the web page or item description of the content, or any other suitable indication from the user 101.

In block 215, the CDS 150 can provide a preview to the user 101 to help the user 101 determine if the content is desirable. The preview may be a portion or example of the written content, pictures, video, music, or any content. In an alternate embodiment, the CDS 150 may omit the preview of the item. For example, the content may be self-explanatory to the user 101, the item description may be sufficient, the content may be configured in such a way that a preview can not be extracted, or for any other reason the preview may be omitted.

In block 220, the CDS 150 offers the user 101 an opportunity to purchase the content. The CDS 150 may present the user 101 with a module or button on the web browser 115 of the user network device 110. Alternatively, the CDS 150 may present a popup window, hyperlink, or any other user interface module to offer the purchase opportunity to the user 101. Throughout the specification, the purchase button, purchase module, purchase screen, purchase popup or other embodiment of the purchase option shall be referred to as the purchase button.

Additionally or alternative, when the CDS 150 offers the user 101 a preview, the full content is downloaded to the user device 110. The downloaded content contains computer instructions, such as a Java Script, that instruct the user device 110 to hide, disable, or delete the content or otherwise render the content unusable to the user 101 when the user device 110 requests a refund. Additionally or alternatively, the downloaded content contains computer instructions that instruct the user device 110 to hide, disable, or delete the content or otherwise render the content unusable to the user 101 if the user 101 does not purchase the content after the preview. Additionally or alternatively, the downloaded content contains computer instructions that instruct the user device 110 to present the full content to on the user device 110 substantially at the time that the user 101 initiates a purchase of the content. The presentation can be made before the transaction is conducted. The download allows the content to be available to the user 101 immediately upon purchase with no delay for download.

The purchase module presented by the CDS 150 offers the user 101 a one-click refund option along with the purchase option. A one-click refund would require the user 101 to only click a single button or in another way initiate a refund with a single action. The one-click refund option is displayed to the user 101 before the purchase is made to encourage the purchase. Additionally or alternatively, the one-click refund button is displayed during the usage and evaluation of content. The user 101 will not be required to return to the CDS 150, find the content page, and find the refund option to obtain a refund. The term “one-click” is used throughout the specification to indicate the simplicity and accessibility of the refund button. It would be understood by one skilled in the art that the refund could be obtained by a process that requires more than one click, such as two clicks or three clicks.

The refund button is displayed to provide a level of comfort to the user 101 that if the content is not what the user 101 expected or needed the user 101 will be able to quickly, securely, and easily obtain a refund. The CDS 150 would expect that the refund button would encourage a user 101 to commit to the purchase more readily and thus increase the purchases of the content. With the refund button, the user 101 will not be required to call customer service or return to the CDS 150, find the content page, and find the refund option to obtain a refund. Throughout the specification, the refund button, refund module, refund screen, refund popup or other embodiment of the one-click refund option shall be referred to as the refund button.

In block 225, by actuating the purchase button, the user 101 purchases the content with any financial account available to the user 101 and accepted by the CDS 150. For example, the user may have a prepaid account on the CDS 150, a credit or debit card account associated with the user account on the CDS 150, a separate financial account that is accessed by the CDS 150 when a purchase is made, or any other financial account that can be used to conduct the transaction.

In the exemplary embodiment, the CDS 150 does not charge the financial account of the user 101 immediately. Even if the CDS 150 does not immediately charge the account, the CDS 150 may check the financial account of the user 101 to determine if the transaction is likely to be approved and to be processed. For example, the CDS 150 can determine if a credit account associated with the user 101 is valid, current, and not over the credit limit or whether a user account on the CDS 150 is funded. If the account does not meet a threshold of requirements that would indicate that a successful transaction is likely, the CDS 150 may refuse to provide the content to the user 101 until a successful transaction is achieved. In an alternate embodiment, the CDS 150 may provide the content to the user 101 in anticipation of a successful transaction without performing an assessment of the financial account of the user 101.

In block 230, the CDS 150 provides the content to the users 101 that purchase the content. In an alternate exemplary embodiment, the refund button is displayed on the same user interface on which the content is displayed. Alternatively, the refund button is displayed in conjunction with the content. The user 101 can directly access the refund from the user interface. The refund button is visible and an easy for a user 101 to locate while evaluating the content. In an exemplary embodiment, the refund button is prominently presented to the user 101 before the purchase is transacted and maintains substantially the same position and appearance to allow easy location and initiation by the user 101 throughout the process. Alternatively, the refund button employs other methods of remaining accessible. The refund button may be presented on the user interface containing the purchase option and additionally or alternatively on the user interface containing the content. Additionally or alternatively, the refund option may be presented on a separate user interface in conjunction with the purchase option and/or the content.

The CDS 150 establishes the length of time that the user 101 may possess the content before the sale becomes final. The CDS 150 communicates to the user 101 the deadline before which the refund button must be clicked. In an exemplary embodiment, the deadline for the refund is displayed to the user 101 with the refund button.

In block 235, the method determines if the user 101 has clicked or otherwise initiated the refund option. If the user 101 has not requested a refund, the method 200 follows the “NO” branch of block 235 to block 240. If the user has requested a refund, the method 200 follows the “YES” branch of block 235 to block 250.

Following the “YES” branch of block 235 to block 250, the CDS 150 instructs the web browser 115 or other communication module operating on the user device 110 to make the content unusable. For example, the CDS 150 may hide, retrieve, scramble, blur, delete, or deny access to the content from the user device 110 or otherwise make the content unusable in any other suitable manner. Alternatively, the content contains computer instructions, such as Java Script, to make the content unusable. The instructions can direct the user device 110 to hide, scramble, blur, delete, or deny access to the content from the user device 110 or otherwise make the content unusable in any other suitable manner.

In block 255, the CDS 150 receives the request for a refund. The CDS 150 cancels the purchase transaction. In the exemplary embodiment, the purchase that was initiated by the user 101 to receive the content is terminated by the CDS 150 before the financial account is charged. In an alternate embodiment, if the CDS 150 has previously charged the financial account of the user 101 at the time of purchase, then the charge can be refunded to the financial account of the user 101 or refunded to the user 101 in another manner, such as a purchase credit, cash refund, or any other refund mechanism.

In an exemplary embodiment of the invention, the user device 110 maintains a status list of content that has been refunded and thus is unavailable for the user 101. By maintaining the status list on the user device 110, the user 101 will not be required to wait for the user device 110 to contact the CDS 150 to verify the purchase and refund status before the content can be utilized. If user 101 attempts to view content that has been refunded, the user device 110 can make the content unusable as discussed above.

Additionally or alternatively, the status list may be maintained on the CDS 150. The user device 110 can contact the CDS 150 to verify the status of content before presenting the content to the user 101. In a certain embodiment, if a user 101 has purchased the content on one user device 110, the CDS 150 may allow the content to be presented to the user 101 on a second device. In a certain embodiment, the user device 110 or the second user device can present the content to the user 101 during the verification process to prevent the user 101 from being required to wait for verification. If the verification process determines that the purchase has been refunded, then the content can be rendered unusable to the user 101 via any of the previously discussed methods or any other suitable method.

Following the “NO” branch of block 235 to block 240, the method 200 determines if the configured time deadline for requesting a refund has elapsed. If the deadline for requesting a refund has not elapsed, then the method 200 follows the “NO” branch of block 240 back to block 235. Block 235 functions as described previously in the method 200. If the deadline for requesting a refund has elapsed, then the method 200 follows the “YES” branch of block 240 back to block 245.

Following the “YES” branch of block 240 to block 245, the user 101 has not requested a refund by the deadline, the refund module is removed, and the user 101 can no longer obtain a refund. In an exemplary embodiment, the user device 110 is instructed to hide the refund button. In an alternate embodiment, the refund button continues to be displayed to the user 101, but the CDS 150 ignores any attempts to obtain a refund after the deadline has passed.

If the deadline has elapsed and the user 101 has not requested a refund, the CDS 150 processes the transaction to complete the purchase of the content. For example, the CDS 150 may transfer funds from a user account on the CDS 150 or conduct a transaction with any other account that the user 101 has associated with the user account, such as a credit card, debit card, or stored value account. With the transaction completed, the user 101 has completed a purchase of the content from the CDS 150.

In an alternate embodiment, if the CDS 150 has previously conducted the transaction, the CDS 150 may update the status of the transaction to note that the one-click refund is expired.

After block 220, the method 200 ends.

### General

Users may, in appropriate circumstances, limit or otherwise affect the operation of the features disclosed in the specification. For example, users may be given an initial opportunity to opt-in or opt-out of the collection or use of certain data or the activation of certain features. In addition, a user may change the manner in which the features are employed, including for situations in which a user may have concerns regarding his privacy. Instructions may be provided to notify the users regarding policies about the use of information, including personally identifiable information and receipt information, and manners in which the users may affect such use of information.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A computer-implemented method to provide options to refund purchases for electronic content via refund controls displayed with electronic content, comprising:
communicating, by a computing device, a purchase control to a user network device for display on the user network device, selection of the purchase control on the user network device initiating a purchase of electronic content associated with the purchase control;
communicating, by the computing device, a first refund control with the purchase control for display on the user network device with the purchase control;
receiving, by the computing device, an instruction to initiate a purchase of the electronic content based on a received input of a selection of the purchase control;
providing, by the computing device, the electronic content to the user network device for display on the user network device, the electronic content comprising instructions instructing the user network device to render the electronic content unusable on the user network device upon receiving an input of a selection of a second refund control while the second refund control is valid;
communicating, by the computing device, the second refund control with the provided electronic content for display on the user network device with the provided electronic content, the second refund control being valid for a length of time during which the refund of the purchased electronic content can be initiated by activation of the second refund control;
refunding, by the computing device, the purchase of the electronic content in response to receiving an input of an initiation of the refund control while displayed on the user network device concurrently with the display of the provided electronic content and during the length of time during which the refund control is valid; and
conducting, by the computing device, the purchase if the length of time is exceeded and the second refund control has not been activated.

2. The method of claim 1, wherein conducting the purchase comprises submitting a payment request to a financial account of the user.

3. The method of claim 1, wherein refunding the purchase of the electronic content comprises voiding the transaction prior to submitting a payment request.

4. The method of claim 1, further comprising presenting, by the computing device, a preview of the electronic content to the user.

5. The method of claim 4, further comprising:
transmitting, by the computing device to the user network device, the electronic content at the time of the presentation of the preview;
transmitting, by the computing device to the user network device, computer instructions for the user device to present the electronic content in response to an indication that the user has purchased the content; and
executing the instructions on the user network device to present the content.

6. The method of claim 1, wherein the instructions instructing the user network device to render the electronic content unusable on the user network device comprise instructions instructing the user network device to hide, scramble, blur, delete, or deny access to the electronic content.

7. The method of claim 1, wherein the step of conducting of the purchase transaction occurs at the time of the step of receiving an indication that the user initiated a purchase of the electronic content.

8. The method of claim 1, wherein the second refund control presented to the user requires only a single action from the user to initiate, and wherein the computing device processes a transaction to refund the purchase in response to receiving an indication that the second refund control has been initiated via the user network device and without further action of the user with respect to the user network device.

9. The method of claim 1, further comprising transmitting, by the computing device and to the user network device for presentation on the user network device, the time by which the refund must be initiated before the second refund control is no longer valid.

10. A computer program product, comprising:
a non-transitory computer-readable medium having computer-readable program instructions embodied thereon that when executed by a computer cause the computer to provide options to refund purchases for electronic content via refund controls displayed with electronic content, the computer-readable program instructions comprising:
computer-readable program instructions to communicate a control to purchase electronic content to a user network device for display on the user network device, selection of the purchase control on the user network device initiating a purchase of electronic content associated with the purchase control;
computer-readable program instructions to receive an instruction to initiate a purchase of the electronic content based on an input of a selection of the purchase control;
computer-readable program instructions to communicate the electronic content to the user network device for display on the user network device, wherein the electronic content comprises instructions instructing the user network device to render the electronic content unusable on the user network device upon receiving an input of a selection of a refund control while displayed on the user network device concurrently with the display of the provided electronic content and within the length of time during which the refund control is valid; and
computer-readable program instructions to conduct the transaction if the length of time is exceeded and the refund control has not been initiated.

11. The computer program product of claim 10, further comprising computer-readable program instructions to communicate the refund control with the purchase control to the user network device for display on the user network device with the purchase control, selection of the refund control initiating a refund of electronic content purchased via the purchase control.

12. The computer program product of claim 10, further comprising computer-readable program instructions to communicate the refund control with the provided content to the user network device for display on the user network device with the provided electronic content, the refund control being valid for a length of time during which the refund of the purchased content can be initiated.

13. (canceled)

14. The computer program product of claim 10, wherein conducting the purchase comprises submitting a payment request to a financial account of the user.

15. The computer program product of claim 10, wherein refunding the purchase of the electronic content comprises voiding the transaction prior to submitting a payment request.

16. The computer program product of claim 10, wherein the instructions instructing the user network device to render the electronic content unusable on the user network device comprise instructions instructing the user network device to hide, scramble, blur, delete, or deny access to the content.

17. The computer program product of claim 10, further comprising computer-readable program instructions to present a preview of the electronic content to the user.

18. The computer program product of claim 10, wherein the refund control presented to the user via the user network device requires only a single action from the user to initiate and wherein the purchase is refunded in response to the refund control being initiated on the user network device without further action of the user with respect to the user network device.

19. The computer program product of claim 10, further comprising computer-readable program instructions to transmit, to the use network device for presentation to the user via the user network device, the time by which the refund must be initiated before the refund control is no longer valid.

20. A system to provide options to refund purchases for electronic content via refund controls displayed with electronic content, comprising:
a network device;
a storage device; and
a processor communicatively coupled to the storage device and the network device, wherein the processor executes application code instructions that are stored in the storage device to cause the system to:
communicate, to a user network device, a refund control with a provided electronic content for display on the user network device with a purchase control, selection of the refund control initiating a refund of electronic content purchased via the purchase control;
receive, from the user network device, an instruction to initiate a purchase of the electronic content based on an input of a selection of the purchase control;
transmit, to the user network device, the electronic content for display on the user network device, wherein the electronic content comprises instructions instructing the user network device to render the content unusable on the user network device upon receiving an input of a selection of the refund control within the length of time during which the refund control is valid;
refund the purchase of the electronic content if the refund control is initiated during a length of time for which the refund control is valid and in response to the refund control being initiated while displayed on the user network device concurrently with the display of the provided electronic content; and
conduct the purchase if the length of time is exceeded and the refund has not been initiated.

21. The system of claim 20, further comprising:
an application executing on the user network device; and
wherein the processor is further configured to execute computer-readable program instructions stored in the storage medium to cause the system to:
receive instructions to render the electronic content unusable on the user network device upon selection of the refund control within the length of time during which the refund control is valid; and
execute the instructions on the user network device to render the electronic content unusable on the user network device in response to initiation of the refund before the length of time is exceeded.

22. The system of claim 20, wherein the processor is further configured to execute computer-readable program instructions stored in the storage medium to cause the system to communicate the refund control with the purchase control to the user network device for display on the user network device with the purchase control, selection of the refund control initiating a refund of electronic content purchased via the purchase control.

23. The system of claim 20, wherein the processor is further configured to execute computer-readable program instructions stored in the storage medium to cause the system to communicate the refund control with the provided content to the user network device for display on the user network device with the provided electronic content, the refund control being valid for a length of time during which the refund of the purchased electronic content can be initiated.

24. The system of claim 20, wherein the processor is further configured to execute computer-readable program instructions stored in the storage medium to cause the system to transmit, to the user network device, a preview of the electronic content to the user for display via the user network device.

25. The system of claim 21, wherein the instructions to the user network device instructing the user network device to render the content unusable on the user network device comprise instructions instructing the user network device to hide, scramble, blur, delete, or deny access to the electronic content.

26. The system of claim 20, wherein the processor is further configured to execute computer-readable program instructions stored in the storage medium to cause the system to transmit, to the user network device and for display to the user via the user network device, the time by which the refund must be initiated before the refund control is no longer valid.

27. (canceled)

28. The product of claim 17, further comprising:
computer program instructions to transmit, to the user network device, the electronic content at the time of the presentation of the preview;
computer program instructions to transmit, to the user network device, computer instructions for the user device to present the electronic content in response to an indication that the user has purchased the electronic content; and
computer program instructions to execute the instructions on the user network device to present the electronic content.

29. The system of claim 24, wherein the refund control presented to the user requires only a single action from the user to initiate and wherein the purchase is refunded in response to the refund control being initiated on the user network device without further action of the user with respect to the user network device.

30. The method of claim 1, wherein the first refund control and the second refund control are the same control.
